(19) United States
(12) Patent Application Publication
(10) Pub. No.: US 2007/0121078 A1
(43) Pub. Date: May 31, 2007

(54) Light-valve projection systems with light recycling

(75) Inventor: Adrianus J.S.M. De Vaan, S-Hertogenbosch (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN NETHERLANDS (NL)

(21) Appl. No.: 10/586,180

(22) PCT Filed: Jan. 25, 2005
(86) PCT No.: PCT/IB05/50296

§ 371 Date: Jul. 17, 2006

Related U.S. Application Data
(60) Provisional application No. 60/540,711, filed on Jan. 30, 2004.

(51) Int. Cl. G03B 21/00; G03B 21/14

(52) U.S. Cl. 353/31; 353/97

(57) ABSTRACT

A light-valve system adapted to recycle light reflected from the light-valve in order to improve the brightness of the image. Illustratively, this reflected light is the dark-state light of an image. The system includes a light-valve, which is optically coupled to a polarization discriminator; and a light recycling device, which selectively alters the polarization state of light reflected by the polarization discriminator back into the system, wherein the reflected light is transmitted to an imaging surface increasing the brightness of an image.

Liquid crystal (LC) technology has been applied in projection displays for use in projection televisions, computer monitors, point of sale displays, and electronic cinema to mention only a few applications.

A more recent application of LC devices is the reflective LC display on a silicon substrate (LCOS). Silicon-based reflective LC displays often include an active matrix array of complementary metal-oxide-semiconductor (CMOS) transistors/switches that are used to selectively rotate the axes of the liquid crystal molecules. As is well known, by application of a voltage across the LC cell, the plane of polarization of the reflected light is selectively rotated. As such, by selective switching of the transistors in the array, the LC medium can be used to modulate the light with image information. This modulated light can then be imaged on a screen by projection optics thereby forming the image or ‘picture.’

In many LCD systems, the light from a source is selectively polarized in a particular orientation prior to being incident on the liquid crystal material. This is often carried out using a polarizer between the light source and the liquid crystal. As can be appreciated, this type of system will result in a significant loss of light. For example, in a system where the light is randomly polarized or unpolarized, half of the light energy is not transmitted to the liquid crystal, and is therefore, lost. Moreover, each pixel that is ‘dark’ in a particular frame or image results from the prevention of light from reaching the image surface. Often, the creation of dark-state light results from the polarization selection by a device (e.g., a polarization beamsplitter). However, this results inefficient light loss at the imaging surface. The inefficiencies of known systems can have deleterious effects on the image displayed. For example, losses in light energy can result in reduced brightness.

In flash-illumination systems, where the display is illuminated with a single color at a time and this color is sequentially changed, by definition two thirds of the light from the white-light source is lost. To wit, if red is illuminating the screen in a particular frame, the green and blue light are lost. In such systems, a color wheel or other type of time-varying light filter may be used to selectively project light onto the display, and selectively reflect or absorb the other light. Like known LCD-based systems, known flash-illumination systems are exceedingly inefficient from the perspective of lost brightness.

What is needed therefore is a method and apparatus that addresses at least the shortcomings of known systems described above.

In accordance with an example embodiment, a light-valve system adapted to recycle light includes a light-valve, which is optically coupled to a polarization discriminator; and a light recycling device, which selectively alters the polarization state of light reflected by the polarization discriminator back into the system, wherein the reflected light is transmitted to an imaging surface increasing the brightness of an image.

In accordance with another example embodiment, a method of recycling light in a light-valve system includes selectively reflecting a portion of light received from a light-valve back into the system. The method also includes selectively altering the polarization state of light reflected back into the system; and transmitting the reflected light to an imaging surface increasing the brightness of an image

The invention is best understood from the following detailed description when read with the accompanying drawing figures. It is emphasized that the various features are not necessarily drawn to scale. In fact, the dimensions may be arbitrarily increased or decreased for clarity of discussion.

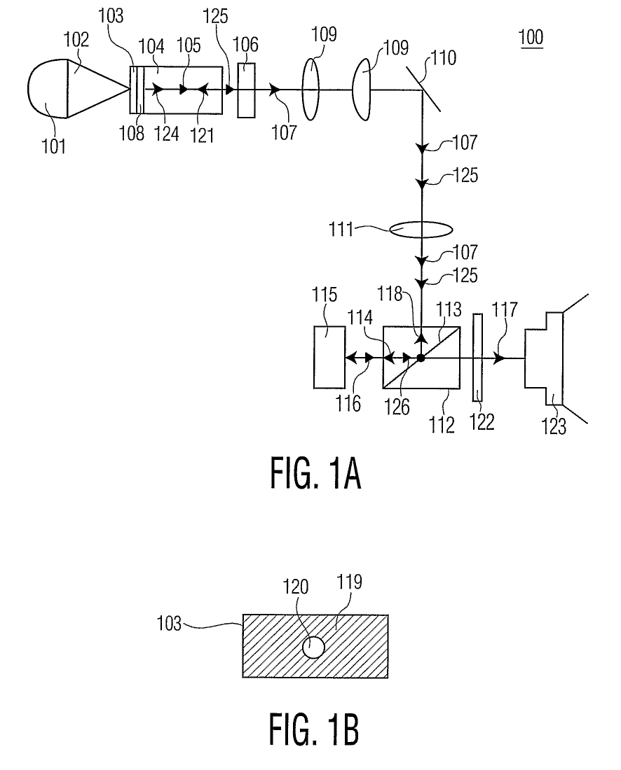

FIG. 1a is a schematic diagram of a light-valve projection system in accordance with an example embodiment.

FIG. 1b is a perspective view of a reflective element with an aperture in accordance with an example embodiment.

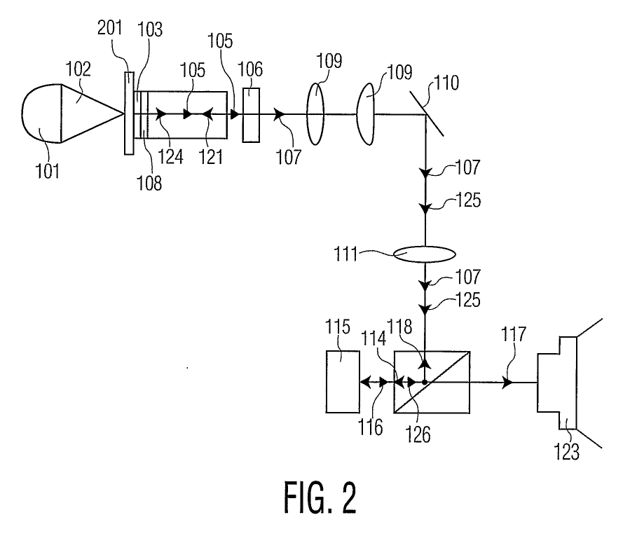

FIG. 2 is a schematic diagram of a light-valve projection system in accordance with an example embodiment.

In the following detailed description, for purposes of explanation and not limitation, example embodiments disclosing specific details are set forth in order to provide a thorough understanding of the present invention. However, it will be apparent to one having ordinary skill in the art having had the benefit of the present disclosure, that the present invention may be practiced in other embodiments that depart from the specific details disclosed herein. Moreover, descriptions of well-known devices, methods and materials may be omitted so as to not obscure the description of the present invention. Wherever possible, like numerals refer to like features throughout.

Briefly, in accordance with example embodiments, light-valve projection systems include a method and apparatus for recycling light to improve the overall brightness of the image at the viewing surface (projection screen). Illustratively, the projection systems of example embodiments are LCD-based, and include an optical structure, which recycles light that is not initially transmitted to the projection optics (e.g., dark state light). Illustratively, the recycled light is reflected back into the system by a polarization discriminator. Other light that is reflected back into the system may be similarly recycled by the optical structure. This recycling allows light that is precluded from reaching the screen initially to reach the screen, and thus increase the overall brightness levels of the image.

FIG. 1a shows a light-valve system 100 for color sequential illumination in accordance with an example embodiment. The light-valve system is illustratively a color sequential system with an LCD light-valve. As described more fully herein, this is merely an illustrative embodiment. In fact, other light-valve systems may benefit from the recycling of light realized from the example embodiments.

The light-valve-system 100 includes a light source (not shown) that is disposed in a reflecting element 101, illustratively an elliptical/ellipsoid-shaped reflective element. As described in further detail below, the light 102 is substantially unpolarized multi-chromatic light. To wit, the light 102 from the light source is unpolarized or randomly polarized white light in the visible spectrum. Examples of a suitable light source include high-intensity gas discharge lamps such as ultra high pressure (UHP) gas discharge lamps, which are well known in the art.

The light 102 is incident on a reflective element 103 coupled to a rod integrator 104. The reflective element 103 is shown on further detail in FIG. 1b. The reflective element 103 has reflective surfaces 119 on its opposing sides, and an aperture 120 that is substantially centered on the surface. The aperture 120 serves as the entrance to the rod integrator for the light 102, and as an exit opening for light returning in a direction of propagation opposite that of light 102. Moreover, the reflective element 103 usefully reflects returning light (i.e., light propagating toward the reflective element 102) that is incident thereon. It is noted that the details of this returning light will become clearer as the present description continues.

The portion of light 102, which is incident on the opening 120, is admitted to the rod integrator 104, while light which is incident on the reflective surface 119 is reflected back to the reflective element 101. This light may then be reflected back by the element 101 so that it is incident on the opening 120 and ultimately may improve the efficiency of polarized light transmitting to the imaging surface (not shown).

A quarter-wave plate or similar retarder 108 is disposed adjacent to the reflective element 108, and, as described more fully herein, is useful in the recycling of light returned to the system. The quarter-wave retarder 108 usefully has a transmission axis that is at 45° or π/4 relative to the optic axis of a reflective polarizer 106. The rod integrator 104 is useful in providing a more uniform light beam to the light-valve and thus the imaging surface or screen. To this end, the rod integrator 104 is illustratively a waveguide that substantially exhibits total internal reflection (TIR). For example, the integrator may be a cylindrical device or polygonal device with a rectangular or square cross-section.

In accordance with one illustrative embodiment, the rod integrator is rectangular that has a height-to-width ratio that is substantially identical to the ratio of the height to the width of the active surface of the light-valve of the system 100 (e.g., the ratio of the height to width of an LCOS device). Further details of the rod integrator assembly may be found in U.S. Pat. Publication No. 2003/0086066 A1 to Kato, the disclosure of which is specifically incorporated herein by reference.

The light-valve system 100 also includes lens elements 109, which usefully focus or condense the light from the rod integrator/reflective polarizer in order to maintain the integrity of the light incident on the light-valve. A mirror device 110 is usefully included to direct the light from/to the rod integrator/reflective element. As is known, the mirror 110 is useful in achieving a dimensionally compact system. The light reflected from the mirror is incident on another lens 111, again useful in maintaining the integrity of the light.

The light-valve system 100 includes a polarization discriminator 112, which is illustratively a polarization beamsplitter (PBS). The PBS is illustratively used as a reflective PBS, which reflects light of a first polarization state incident on an interface 113 of the PBS in a direction that is perpendicular to its original direction of propagation. Light of a second polarization state that is orthogonal to the first polarization state is transmitted substantially along its original trajectory. The use of a reflective PBS is beneficial because it is nearly completely efficient in reflecting the light in the manner described.

The system 100 includes a light-valve 113, which is illustratively a LCOS device; although other types of light-valves such as reflective twisted nematic (TN) LC-based TFT devices may be used. Characteristically, the light-valve 113 selectively alters the polarization state of some picture elements (pixels) and does not alter others, thereby creating bright and dark pixels on the image surface. Generally, the light-valve 113 may be one of a number of types of spatial light modulators. Illustratively, light-valves including, but not limited to antiferroelectric and ferroelectric LC-based devices, horizontally or vertically oriented LC-based devices and high molecular-diverging LC-type devices may be used. The system 100 also includes a light shutter or a color filter 122, which selectively transmits red, blue and green light sequentially, thereby providing color sequential imaging to projection optics 123. Beneficially, the color filter 122 may be as described in U.S. Pat. No. 6,273,571 to Sharp, et al. and assigned to ColorLink, Incorporated, the disclosure of which is specifically incorporated herein by reference. Additionally, other color shutters or color filters manufactured by ColorLink, Incorporated may be used in this manner. In operation, the color filter 122 sequentially passes light of red, green and blue to the projection optics 123, and thus to the display surface (not shown).

In operation light 102 is incident on the reflective element 103 with some of the light 102 passing through the aperture 120. The light that passes through the aperture 120 traverses the quarter wave retarder 108, and the remaining light is reflected back toward the reflective element 101 by the reflective surface 119 of reflective element 103. The light 105 emerges from the quarter wave retarder 108 having orthogonal polarization components. The light 105 then traverses the rod integrator 104 and is homogenized or made more uniform, as is explained more fully in the application to Kato.

The reflective polarizer 106 reflects one of the polarization states (e.g., s-polarized light), while allowing light of the orthogonal state (e.g., p-polarized light) to emerge as polarized light 107. The polarized light 107 is then incident on the lens elements 109 and the mirror 110. The mirror 110 reflects the light in an orthogonal direction, and this light traverses the lens element 111.

Upon emerging from the lens element 111, the polarized light 107 is incident on the PBS 112, and substantially all of this polarized light is reflected from the interface 113 as reflected light 114. The light 114 is incident upon the light-valve 115. The pixels of the light-valve 112 selectively alter the polarization state of some of the light 114 causing it to undergo an orthogonal transformation of polarization state, while leaving some of the light 114 substantially in its original polarization state. This selective alteration of the polarization state is carried out on a pixel-by-pixel basis as is known to one of ordinary skill in the art.

In the present example embodiment, the light is reflected as light 116, and the light, which has undergone a polarization transformation to a polarization state that is orthogonal to its original polarization state (i.e., the p-state of light 107, 114), is transmitted through the PBS 112 and ultimately effects the ‘bright’ pixels at the imaging surface. The light which does not undergo a polarization transformation upon emerging from the reflective light-valve is again reflected at the interface 113 as reflected light 118. Because this light is not ultimately incident on the image surface, it effects the ‘dark’ pixels of the image.

As can be appreciated, the light 116 is white light. In order to form the color image on the screen, the color filter or shutter 122 sequentially scrolls the colors to illuminate the projection optics 123 and thus form the image. The details of this image formation process using the color filter 122 are known to the artisan of ordinary skill, and as such, these details are omitted so as to not obscure the disclosure of the example embodiments.

As can be readily appreciated, the light 118, which constitutes the dark light or dark pixels is reflected back to the system 100, and would otherwise be lost in the system. However, in accordance with example embodiments, this reflected light is substantially recovered and introduced substantially uniformly across the image surface (i.e., recycled). In this manner, the overall brightness of the image is improved compared to known systems. Certain aspects of the recycling of the dark-state light as well as other light are described presently in the context of example embodiments.

The light 118 reflected at the PBS is returned to the reflective polarizer 106, where, because its polarization state is parallel to the transmission axis of the polarizer 106, it is transmitted through the rod integrator 104. This light 121 traverses the rod integrator 104 and the quarter wave retarder 108 where its polarization state is rotated by 45°. Next, some of the light is reflected off the inner reflective surface (immediately adjacent to the quarter wave plate 108), traverses the quarter wave retarder 108 again and emerges as light 124. Light 124 is in a state of polarization that is orthogonal to the state of polarization of light 118 (e.g., s-polarized light in keeping with the above example). Moreover, light 124 is in a state of polarization that is substantially reflected by the reflective polarizer 108. As such, this light again traverses the rod integrator 104, the quarter wave retarder 108, is reflected from the reflective surface 119 and traverses the quarter wave retarder 108 again. Thus, upon incidence at the reflective polarizer 106, this light 125 has a polarization vector that is substantially parallel to the transmission axis of the reflective polarizer 106 and is thus transmitted therethrough.

According to the present example embodiment, the dark state light that is normally lost is now reintroduced to the system 100. To this end, this light has a polarization state that is parallel to the transmission axis of the reflective polarizer 106 (p-polarized light in keeping with the above example) and traverses the lens elements 109, the mirror 110 and the lens element 111. As described previously, this polarized light is reflected toward the light-valve 115 by the PBS 112. Uniformly, the light-valve 115 transforms the polarization state of light 125 to light 126, which is in an orthogonal polarization state to the p-state of light 125 so that it is transmitted by the PBS 112 and to the projection optics. Stated differently, all of the pixels of the light-valve are in a state that will effect a transformation of the polarization state of light 125 into a polarization state that is orthogonal to the polarization state of light 125 (e.g., the p-polarized light 125 is transformed uniformly into s-polarized light 126). This light 126 is then incident on the color filter 122 and ultimately onto the image surface via the projection optics 123.

Through the example embodiments described, the dark state light is reintroduced or recycled as light 126. This light beneficially allows the overall brightness of the image to be improved by providing otherwise lost light to the image surface.

It is noted that the light that is reflected back toward the reflective element 101 from the rod integrator 104 may also be re-introduced into the system. To wit, the light that is reflected by the reflective polarizer 106 or traverses the reflective polarizer 106 in the manner of light 121, or both, and traverses the opening 120 is reflected by the reflective element 101. At least portions of this light then may be reintroduced via the opening 120. This light must undergo any necessary polarization transformation so that its polarization state is substantially parallel to the transmission axis of the reflective polarizer 106. As can be appreciated this further increases the recycling of light to further improve the brightness of the image.

FIG. 2 shows a light-valve projection system 200 for color sequential illumination in accordance with an example embodiment. The system 200 is substantially the same as the system 100, however effects the sequential illumination in a different manner. To wit, rather than the color filter 122, the system 200 incorporates a color wheel 201 that includes red, blue and green. The color wheel thus scrolls the colors in sequence and in a manner that is well known in the art. As such, many of the details of the system 100 apply to the description of the system 200 and are thus omitted in the interest of brevity.

The example embodiments having been described in detail in connection through a discussion of exemplary embodiments, it is clear that modifications of the invention will be apparent to one having ordinary skill in the art having had the benefit of the present disclosure. Such modifications and variations are included in the scope of the appended claims.

1. A light-valve system adapted to recycle light, comprising:
a light-valve, which is optically coupled to a polarization discriminator; and
a light recycling device, which selectively alters the polarization state of light reflected by the polarization discriminator back to the system, wherein the reflected light is transmitted to an imaging surface increasing the brightness of an image.

2. A light-valve system as recited in claim 1, wherein the reflected light substantially uniformly illuminates the imaging surface.

3. A light-valve system as recited in claim 1, wherein the light recycling device includes a rod integrator having a reflective element and an optical retarder at a first end, and a reflective optical retarder at a second end.

4. A light-valve system as recited in claim 1, wherein the optical retarder is a quarter-wave retarder.

5. A light-valve retarder as recited in claim 3, wherein the reflective optical retarder transmits light of a first polarization state and reflects light that is of a second polarization state that is orthogonal to the first polarization state, and wherein the first polarization state is substantially parallel to a transmission axis of the optical retarder at the first end.

6. A light-valve system as recited in claim 1, further comprising a device adapted to sequentially provide red, green and blue light from a light source.

7. A light-valve system as recited in claim 6, wherein the device is a color filter.

8. A light-valve system as recited in claim 6, wherein the device is a color wheel.

9. A light-valve system as recited in claim 1, wherein the light-valve is one of a liquid crystal light-valve, a ferroelectric liquid crystal light-valve or a non-ferroelectric liquid crystal light-valve.

10. A light-valve system as recited in claim 9, wherein the liquid crystal light-valve is one of a twisted nematic liquid crystal light-valve or a liquid crystal on silicon (LCOS) light-valve.

11. A light-valve system as recited in claim 1, wherein the system is a color sequential system.

12. A method of recycling light in a light-valve system, the method comprising:
selectively reflecting a portion of light received from a light-valve back to the system;
selectively altering the polarization state of light reflected back into the system; and
transmitting the reflected light to an imaging surface increasing the brightness of an image.

13. A method as recited in claim 12, wherein the portion of light substantially uniformly illuminates the imaging surface.

14. A method as recited in claim 12, further comprising:
providing a rod integrator having a reflective element and an optical retarder at a first end, and a reflective optical retarder at a second end.

15. A method as recited in claim 14, further comprising sequentially transmitting one of red, blue or green light from a light source.

16. A method as recited in claim 12, wherein the light-valve is one of a liquid crystal light-valve, a ferroelectric liquid crystal light-valve or a non-ferroelectric liquid crystal light-valve.

17. A method as recited in claim 16, wherein the liquid crystal light-valve is one of a twisted nematic liquid crystal light-valve or a liquid crystal on silicon (LCOS) light-valve.

18. A light-valve system as recited in claim 1, wherein the system is a color sequential system.
